(19) United States
(12) Patent Application Publication
(10) Pub. No.: US 2023/0199771 A1
(43) Pub. Date: Jun. 22, 2023

(54) METHOD AND DEVICE IN NODES USED FOR WIRELESS COMMUNICATION

(71) Applicants: Lu WU, SHANGHAI (CN); Xiaobo ZHANG, SHANGHAI (CN)

(72) Inventors: Lu WU, SHANGHAI (CN); Xiaobo ZHANG, SHANGHAI (CN)

(73) Assignee: SHANGHAI TUILUO COMMUNICATION TECHNOLOGY PARTNERSHIP (LIMITED PARTNERSHIP), SHANGHAI (CN)

(21) Appl. No.: 18/083,568

(22) Filed: Dec. 19, 2022

(30) Foreign Application Priority Data
Dec. 21, 2021 (CN) 2021115765.8X

(51) Int. Cl. H04W 72/20; H04W 72/12

(52) U.S. Cl. CPC H04W 72/20; H04W 72/12

(57) ABSTRACT

The present application provides a method and device in a node for wireless communications. A first node receives a first information block and a second information block; monitors a control channel candidate scheduling a first cell in a first search space set, the first information block indicates that a scheduling cell of the first cell comprises a second cell, and the second information is used to indicate the first search space set; the second information block comprises at least a first field set in the first field set and a second field set, and the second field set comprises a first field subset; when the second information block does not comprise the first field subset, the first search space set is on the second cell; when the second information block comprises at least one field in the first field subset.

### CROSS REFERENCE TO RELATED APPLICATIONS

This application claims the priority benefit of Chinese Patent Application No. 202111574658.X, filed on Dec. 21, 2021, the full disclosure of which is incorporated herein by reference.

### BACKGROUND

### Technical Field

The present application relates to transmission methods and devices in wireless communication systems, and in particular to a method and device of radio signal transmission in a wireless communication system supporting cellular networks.

### Related Art

In 3rd Generation Partner Project (3GPP) New Radio (NR) Release (R) 15, in the case of cross-carrier scheduling, a control channel candidate of a scheduled cell belongs to a search space set of its scheduling cell, partial optional fields in a search space configuration of the scheduled cell may not exist, and a search space set of the scheduled cell and a search space set of the linked scheduling cell have a same identity. In 3GPP NR R17, it is agreed that a Secondary Cell (SCell) cross-schedules a Primary Cell (PCell)/Primary Secondary Cell (PSCell) and other serving cells, where the configuration of the search space set is a key issue.

### SUMMARY

Inventors have found through researches that how to determine a search space set of a cell is a research focus when cross-carrier scheduling is supported.

To address the above problem, the present application provides a solution. It should be noted that although the above description adopts the scenario of downlink as an example, the present application is also applicable to other scenarios such as uplink and sidelink, where similar technical effects can be achieved. Additionally, the adoption of a unified solution for various scenarios (including but not limited to Downlink, Uplink and Sidelink) contributes to the reduction of hardcore complexity and costs. If no conflict is incurred, embodiments in any node in the present application and the characteristics of the embodiments are also applicable to any other node, and vice versa. And the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:

receiving a first information block and a second information block; and

monitoring a control channel candidate scheduling a first cell in a first search space set;

herein, both the second information block and the first information block are for the first cell, the first information block indicates that a scheduling cell of the first cell comprises a second cell, and the second information block is used to indicate the first search space set; the second information block comprises at least a first field set in the first field set and a second field set, and the second field set comprises a first field subset; when the second information block does not comprise the first field subset, the first search space set is on the second cell; when the second information block comprises at least one field in the first field subset, whether the second information block comprises a target field is used to determine whether a first search space set comprises a control channel candidate on the second cell, and the target field belongs to the first field subset; when the second information comprises the target field, the first search space set comprises a first control channel candidate set and a second control channel candidate set, the first control channel candidate set is on the first cell, and the second control channel candidate set is on the second cell; when the second information block comprises at least one field in the first field subset and the second information block does not comprise the target field, the first search space set is on the first cell.

In one embodiment, a problem to be solved in the present application is: in the case of supporting cross-carrier scheduling, how to determine a search space set of a cell.

In one embodiment, the above method is essential in that whether a first search space set is on a first cell or on a second cell, or both comprises a control channel candidate of a first cell and comprises a control channel candidate of a second cell is determined according to a field comprised/not comprised in the second information block. The advantage of adopting the above method is that it flexibly realizes the configuration of a search space set under multiple situations, and has backward compatibility.

According to one aspect of the present application, it is characterized in that the first cell is a PCell or a PSCell, the second cell is a serving cell other than the first cell in a first cell set, and the first cell set comprises at least the first cell and the second cell.

According to one aspect of the present application, it is characterized in that the second field set also comprises a reference field, and the reference field is a field other than the first field subset in the second field set; the reference field indicates a number of control channel candidate(s) on the first cell in the first search space set, and the target field indicates a number of control channel candidate(s) on the second cell in the first search space set; or, the reference field indicates a number of control channel candidate(s) on the second cell in the first search space set, and the target field indicates a number of control channel candidate(s) on the first cell in the first search space set.

According to one aspect of the present application, it is characterized in that the target field indicates that the first search space set comprises control channel candidate(s) on the second cell.

According to one aspect of the present application, it is characterized in that one field in the first field set comprised in the second information block indicates a first identity; when the first search space set is on the first cell, an identity of the first search space set on the first cell is equal to the first identity; when the first search space set is on the second cell, an identity of the first search space set on the second cell is equal to the first identity; when the first search space set comprises the first control channel candidate set and the second control channel candidate set, the first control channel candidate set belongs to a search space set identified by the first identity on the first cell, and the second control channel candidate set belongs to a search space set identified by the first identity on the second cell.

According to one aspect of the present application, comprising:

receiving a first signaling; and

operating a first signal on the first cell;

herein, the operating action is transmitting, or the operating action is receiving; the first information block indicates a first value; the first signaling occupies a control channel candidate in the first search space set; the first signaling schedules the first signal; when the control channel candidate in the first search space set occupied by the first signaling is on the second cell, the first signaling comprises a first field, and a value of the first field in the first signaling is equal to the first value.

According to one aspect of the present application, it is characterized in that when the control channel candidate in the first search space set occupied by the first signaling is on the first cell, a value of the first field in the first signaling is equal to 0, or, the first field in the first signaling is ignored.

According to one aspect of the present application, it is characterized in that whether the first signaling comprises the first field is related to whether a control channel candidate occupied by the first signaling is on the first cell or on the second cell; when a control channel candidate occupied by the first signaling is on the first cell, the first signaling does not comprise the first field.

The present application provides a method in a second node for wireless communications, comprising:

transmitting a first information block and a second information block;

herein, both the second information block and the first information block are for a first cell, the first information block indicates that a scheduling cell of the first cell comprises a second cell, and the second information block is used to indicate a first search space set; the second information block comprises at least a first field set in the first field set and a second field set, and the second field set comprises a first field subset; when the second information block does not comprise the first field subset, the first search space set is on the second cell; when the second information block comprises at least one field in the first field subset, whether the second information block comprises a target field is used to determine whether a first search space set comprises a control channel candidate on the second cell, and the target field belongs to the first field subset; when the second information comprises the target field, the first search space set comprises a first control channel candidate set and a second control channel candidate set, the first control channel candidate set is on the first cell, and the second control channel candidate set is on the second cell; when the second information block comprises at least one field in the first field subset and the second information block does not comprise the target field, the first search space set is on the first cell.

According to one aspect of the present application, it is characterized in that the first cell is a PCell or a PSCell, the second cell is a serving cell other than the first cell in a first cell set, and the first cell set comprises at least the first cell and the second cell.

According to one aspect of the present application, it is characterized in that the second field set also comprises a reference field, and the reference field is a field other than the first field subset in the second field set; the reference field indicates a number of control channel candidate(s) on the first cell in the first search space set, and the target field indicates a number of control channel candidate(s) on the second cell in the first search space set; or, the reference field indicates a number of control channel candidate(s) on the second cell in the first search space set, and the target field indicates a number of control channel candidate(s) on the first cell in the first search space set.

According to one aspect of the present application, it is characterized in that the target field indicates that the first search space set comprises control channel candidate(s) on the second cell.

According to one aspect of the present application, it is characterized in that one field in the first field set comprised in the second information block indicates a first identity; when the first search space set is on the first cell, an identity of the first search space set on the first cell is equal to the first identity; when the first search space set is on the second cell, an identity of the first search space set on the second cell is equal to the first identity; when the first search space set comprises the first control channel candidate set and the second control channel candidate set, the first control channel candidate set belongs to a search space set identified by the first identity on the first cell, and the second control channel candidate set belongs to a search space set identified by the first identity on the second cell.

According to one aspect of the present application, comprising:

transmitting a first signaling; and

executing a first signal on the first cell;

herein, the executing action is receiving, or, the executing action is transmitting; the first information block indicates a first value; the first signaling occupies a control channel candidate in the first search space set; the first signaling schedules the first signal; when the control channel candidate in the first search space set occupied by the first signaling is on the second cell, the first signaling comprises a first field, and a value of the first field in the first signaling is equal to the first value.

According to one aspect of the present application, it is characterized in that when the control channel candidate in the first search space set occupied by the first signaling is on the first cell, a value of the first field in the first signaling is equal to 0, or, the first field in the first signaling is ignored.

According to one aspect of the present application, it is characterized in that whether the first signaling comprises the first field is related to whether a control channel candidate occupied by the first signaling is on the first cell or on the second cell; when a control channel candidate occupied by the first signaling is on the first cell, the first signaling does not comprise the first field.

The present application provides a first node for wireless communication, comprising:

a first receiver, receiving a first information block and a second information block; monitoring a control channel candidate scheduling a first cell in a first search space set;

herein, both the second information block and the first information block are for the first cell, the first information block indicates that a scheduling cell of the first cell comprises a second cell, and the second information block is used to indicate the first search space set; the second information block comprises at least the first field in a first field set and a second field set, and the second field set comprises a first field subset; when the second information block does not comprise the first field subset, the first search space set is on the second cell; when the second information block comprises at least one field in the first field subset, whether the second information block comprises a target field is used to determine whether a first search space set comprises a control channel candidate on the second cell, and the target field belongs to the first field subset; when the second information comprises the target field, the first search space set comprises a first control channel candidate set and a second control channel candidate set, the first control channel candidate set is on the first cell, and the second control channel candidate set is on the second cell; when the second information block comprises at least one field in the first field subset and the second information block does not comprise the target field, the first search space set is on the first cell.

The present application provides a second node for wireless communications, comprising:

a second transmitter, transmitting a first information block and a second information block;

herein, both the second information block and the first information block are for a first cell, the first information block indicates that a scheduling cell of the first cell comprises a second cell, and the second information block is used to indicate a first search space set; the second information block comprises at least a first field set in the first field set and a second field set, and the second field set comprises a first field subset; when the second information block does not comprise the first field subset, the first search space set is on the second cell; when the second information block comprises at least one field in the first field subset, whether the second information block comprises a target field is used to determine whether a first search space set comprises a control channel candidate on the second cell, and the target field belongs to the first field subset; when the second information comprises the target field, the first search space set comprises a first control channel candidate set and a second control channel candidate set, the first control channel candidate set is on the first cell, and the second control channel candidate set is on the second cell; when the second information block comprises at least one field in the first field subset and the second information block does not comprise the target field, the first search space set is on the first cell.

In one embodiment, the present application has the following advantages over conventional schemes:

it flexibly implements configuration of a search space set under multiple situations;

it has backward compatibility.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first information block, a second information block, and monitoring a control channel candidate scheduling a first cell according to one embodiment of the present application;

FIG. 2 illustrates a schematic diagram of a network architecture according to one embodiment of the present application;

FIG. 3 illustrates a schematic diagram of a radio protocol architecture of a user plane and a control plane according to one embodiment of the present application;

FIG. 4 illustrates a schematic diagram of a first communication device and a second communication device according to one embodiment of the present application;

FIG. 5 illustrates a flowchart of wireless communications according to one embodiment of the present application;

FIG. 6 illustrates a schematic diagram of a first cell and a second cell according to one embodiment of the present application;

FIG. 7 illustrates a schematic diagram of a first cell and a second cell according to another embodiment of the present application;

FIG. 8 illustrates a schematic diagram of a target field according to one embodiment of the present application;

FIG. 9 illustrates a schematic diagram of a target field according to another embodiment of the present application;

FIG. 10 illustrates a schematic diagram of a relation between a first search space set and a first identity according to one embodiment of the present application;

FIG. 11 illustrates a schematic diagram of a relation between a second search space set and a first space set according to one embodiment of the present application;

FIG. 12 illustrates a schematic diagram of a first field in a first signaling according to one embodiment of the present application;

FIG. 13 illustrates a schematic diagram of a first field in a first signaling according to another embodiment of the present application;

FIG. 14 illustrates a structure block diagram of a processor in a first node according to one embodiment of the present application;

FIG. 15 illustrates a structure block diagram of a processor in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

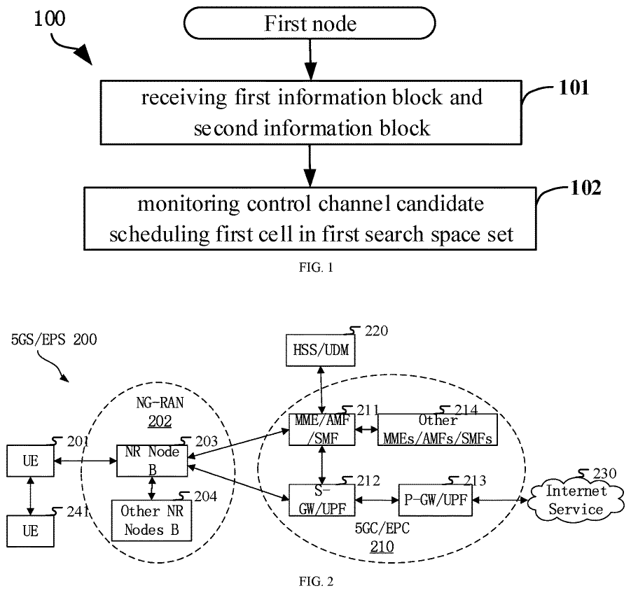

Embodiment 1 illustrates a flowchart of a first information block, a second information block, and monitoring a control channel candidate scheduling a first cell according to one embodiment of the present application, as shown in FIG. 1. In step 100 illustrated by FIG. 1, each box represents a step. and in particular, the order of steps in boxes does not represent chronological order of characteristics between the steps.

In embodiment 1, the first node in the present application receives a first information block and a second information block in step 101; monitors a control channel candidate scheduling a first cell in a first search space set in step 102; herein, both the second information block and the first information block are for the first cell, the first information block indicates that a scheduling cell of the first cell comprises a second cell, and the second information block is used to indicate the first search space set; the second information block comprises at least a first field set in the first field set and a second field set, and the second field set comprises a first field subset; when the second information block does not comprise the first field subset, the first search space set is on the second cell; when the second information block comprises at least one field in the first field subset, whether the second information block comprises a target field is used to determine whether a first search space set comprises a control channel candidate on the second cell, and the target field belongs to the first field subset; when the second information comprises the target field, the first search space set comprises a first control channel candidate set and a second control channel candidate set, the first control channel candidate set is on the first cell, and the second control channel candidate set is on the second cell; when the second information block comprises at least one field in the first field subset and the second information block does not comprise the target field, the first search space set is on the first cell.

In one embodiment, a scheduling cell of the first cell comprises a second cell and the first cell.

In one embodiment, a scheduling cell of the first cell only comprises a second cell and the first cell.

In one embodiment, the first information block indicates that the first cell can be scheduled by a second cell.

In one embodiment, the first information block comprises all or partial fields in an Information Element (IE).

In one embodiment, the first information block comprises an IE CrossCarrierSchedulingConfig.

In one embodiment, the first information block is carried by a higher-layer signaling.

In one embodiment, the first information block is carried by an RRC signaling.

In one embodiment, the first information block indicates an identity of the second cell.

In one embodiment, the first information block comprises at least one field, and a field in the first information block indicates an identity of the second cell.

In one embodiment, the first information block comprises at least one field, and a schedulingCellId field in the first information block indicates an identity of the second cell.

In one embodiment, one field comprises at least one bit.

In one embodiment, an identity of a serving cell is used to identify the serving cell.

In one embodiment, the first cell is a serving cell, the second cell is a serving cell, and the first cell is different from the second cell.

In one embodiment, a signaling scheduling a transmission on a serving cell is transmitted on a scheduling cell of the serving cell.

In one embodiment, a signaling scheduling a transmission on a serving cell occupies time-frequency resources of a scheduling cell of the serving cell.

In one embodiment, a control signaling scheduling a transmission on a serving cell occupies a control channel candidate of a scheduling cell of the serving cell.

In one embodiment, a scheduling signaling of a serving cell is transmitted on a scheduling cell of the serving cell.

In one embodiment, a scheduling signaling of a serving cell occupies time-frequency resources of a scheduling cell of the serving cell.

In one embodiment, a scheduling signaling of a serving cell occupies a control channel candidate of a scheduling cell of the serving cell.

In one embodiment, the second information block comprises partial or all fields in an IE.

In one embodiment, the second information block comprises an IE SearchSpace.

In one embodiment, the second information block is carried by a higher-layer signaling.

In one embodiment, the second information block is carried by an RRC signaling.

In one embodiment, the second information block indicates partial or all information in configuration information in the first search space set.

In one embodiment, the second information block indicates configuration information of the first search space set.

In one embodiment, the second information block indicates partial information in configuration information in the first search space set, and a third information block indicates partial information in configuration information in the first search space set.

In one embodiment, the second information block and the third information block are used together to indicate configuration information of the first search space set.

In one embodiment, the meaning of the phrase of “both the second information block and the first information block being for the first cell” comprises: both the second information block and the first information block are configured to the first cell.

In one embodiment, the meaning of the phrase of “both the second information block and the first information block being for the first cell” comprises: a crossCarrierSchedulingConfig field in an IE ServingCellConfig for the first cell comprises the first information block, and a downlinkBWP-ToAddModList field in an IE ServingCellConfig for the first cell comprises the second information block.

In one embodiment, the meaning of the phrase of “both the second information block and the first information block being for the first cell” comprises: a field in an IE ServingCellConfig for the first cell comprises the first information block, and a field in an IE ServingCellConfig for the first cell comprises the second information block.

In one embodiment, the first search space set comprises a control channel candidate used to schedule a first cell.

In one embodiment, the first search space set only comprises a control channel candidate used to schedule a first cell.

In one embodiment, the first search space set comprises a control channel candidate used to schedule a first cell and other cells.

In one embodiment, the first search space set comprises at least one control channel candidate.

In one embodiment, the first search space set is a search space set, and a search space set comprises at least one control channel candidate.

In one embodiment, a search space set comprises at least one symbol in time domain.

In one embodiment, a search space set comprises at least one Resource Block (RB) in frequency domain.

In one embodiment, a search space set comprises at least one RE.

In one embodiment, for the specific definition of search space set, refer to section 10 in 3GPP TS 38. 213.

In one embodiment, the control channel candidate is a Physical Downlink Control Channel (PDCCH) candidate.

In one embodiment, the control channel candidate is a PDCCH candidate being monitored.

In one embodiment, the control channel candidate is an Enhanced PDCCH (EPDCCH) candidate.

In one embodiment, the control channel candidate occupies multiple REs.

In one embodiment, the control channel candidate occupies one or multiple Control Channel Elements (CCEs).

In one embodiment, a number of CCE(s) occupied by the control channel candidate is equal to one of 1, 2, 4, 8 and 16.

In one embodiment, a CCE comprises 9 Resource Element Groups (REGs), and an REG comprises 4 REs.

In one embodiment, an CCE comprises 6 REGs, and an REG comprises 12 REs.

In one embodiment, for the specific definition of the PDCCH candidate, refer to section 10 in 3GPP TS 38.213.

In one embodiment, an RE occupies a symbol in time domain and a subcarrier in frequency domain.

In one embodiment, the symbol is a single carrier symbol.

In one embodiment, the symbol is a multicarrier symbol.

In one embodiment, the multicarrier symbol is an Orthogonal Frequency Division Multiplexing (OFDM) symbol.

In one embodiment, the multicarrier symbol is a Single Carrier-Frequency Division Multiple Access (SC-FDMA) symbol.

In one embodiment, the multicarrier symbol is a Discrete Fourier Transform Spread OFDM (DFT-S-OFDM) symbol.

In one embodiment, the multicarrier symbol is a Filter Bank Multicarrier (FBMC) symbol.

In one embodiment, the multicarrier symbol comprises a Cyclic Prefix (CP).

In one embodiment, the meaning of the phrase of “monitoring a control channel candidate” comprises: the monitoring refers to blind decoding, that is, a signal is received on a control channel candidate and a decoding operation is performed; if decoding is determined correct according to a CRC bit, it is judged that a control signaling is detected on the control channel candidate; otherwise it is judged that a control signaling is not detected on the control channel candidate.

In one embodiment, the meaning of the phrase of “monitoring a control channel candidate” comprises: the monitoring refers to a coherent detection, that is, a coherent reception is performed on a control channel candidate and energy of a signal acquired after the coherent reception is measured; if the energy of the signal acquired after the coherent reception is greater than a first given threshold, it is judged that a control signaling is detected on the control channel candidate; otherwise it is judged that a control signaling is not detected on the control channel candidate.

In one embodiment, the meaning of the phrase of “monitoring a control channel candidate” comprises: the monitoring refers to an energy detection, that is, energy of a radio signal is sensed on a control channel candidate and is averaged to acquire received energy; if the received energy is greater than a second given threshold, it is judged that a control signaling is detected on the control channel candidate; otherwise it is judged that a control signaling is not detected on the control channel candidate.

In one embodiment, the meaning of the phrase of “monitoring a control channel candidate” comprises: whether there exists a control signaling being transmitted on a control channel candidate is determined according to a CRC.

In one embodiment, the meaning of the phrase of “monitoring a control channel candidate” comprises: whether there exists a control signaling being transmitted on a control channel candidate is not determined before judging whether coding is correct according to a CRC.

In one embodiment, the meaning of the phrase of “monitoring a control channel candidate” comprises: whether there exists a control signaling being transmitted on a control channel candidate is determined according to a coherent detection.

In one embodiment, the meaning of the phrase of “monitoring a control channel candidate” comprises: whether there exists a control signaling being transmitted on a control channel candidate is not determined before a coherent detection.

In one embodiment, the meaning of the phrase of “monitoring a control channel candidate” comprises: whether there exists a control signaling being transmitted on a control channel candidate is determined according to an energy detection.

In one embodiment, the meaning of the phrase of “monitoring a control channel candidate” comprises: whether there exists a control signaling being transmitted on a control channel candidate is not determined before an energy detection.

In one embodiment, the first field set indicates partial information of configuration information of a search space set.

In one embodiment, the second field set indicates partial information of configuration information of a search space set.

In one embodiment, there exists an optional field in only the second field set in the first field set and a second field set, and each field in the second field set is optional.

In one embodiment, the second field set also comprises a field other than the first field subset.

In one embodiment, the second field set comprises a first filed subset and a second field subset.

In one embodiment, the second field set comprises a first filed subset and a second field subset, and the second field subset comprises at least one field.

In one embodiment, the second filed set comprises a first field subset and a second field subset, and the second field subset comprises a nrofCandidates field.

In one embodiment, any field in the first field subset does not belong to the second field subset.

In one embodiment, configuration information of a search space set comprises at least one of an identity on a cell to which it belongs, an identity of an associated Control REsource Set (CORESET), a monitoring period and an offset, a duration, a monitoring pattern, a search space type or a number of PDCCH candidate(s) of each CCE aggregation level.

In one embodiment, for a search space set, a searchSpaceId field indicates its identity on a cell to which it belongs, a controlResourceSetId field indicates an identity of an associated CORESET, a monitoringSlotPeriodicityAndOffset field indicates a monitoring period and an offset, a duration field indicates a duration, a monitoringSymbolsWithinSlot field indicates a monitoring pattern, a searchSpaceType field indicates a search space type, and a nrofCandidates field indicates a number of control channel candidate(s) of each CCE aggregation level.

In one embodiment, a search space type in a search space set is a Common search space (CSS) or a UE-specific search space (USS).

In one embodiment, the first field subset indicates at least one of an identity, a monitoring period and an offset, a duration, a monitoring pattern, or a search space type of an associated CORESET.

In one embodiment, the first field subset indicates an identity, a monitoring period and an offset, a duration, a monitoring pattern, and a search space type of an associated CORESET.

In one embodiment, the first field subset comprises an identity, a monitoring period and an offset, a duration, a monitoring pattern, and a search space type of an associated CORESET.

In one embodiment, the second field subset indicates a number of control channel candidate(s) of at least one CCE aggregation level.

In one embodiment, the second field subset indicates a number of control channel candidate(s) of each CCE aggregation level.

In one embodiment, the first field set comprises a searchSpaceId field.

In one embodiment, the first field subset comprises at least one of a controlResourceSetId field, a monitoringSlotPeriodicityAndOffset field, a duration field, a monitoringSymbolsWithinSlot field, or a searchSpaceType field.

In one embodiment, the first field subset at least comprises a controlResourceSetId field, a monitoringSlotPeriodicityAndOffset field, a duration field, a monitoringSymbolsWithinSlot field, and a searchSpaceType field.

In one embodiment, the second field subset comprises a nrofCandidates field.

In one embodiment, for the specific definition of a searchSpaceId field, a nrofCandidates field, a controlResourceSetId field, a monitoringSlotPeriodicityAndOffset field, a duration field, a monitoringSymbolsWithinSlot field, a searchSpaceType field, refer to section 6.3.2 in 3GPP TS 38.331.

In one embodiment, a search space set is associated with a CORESET.

In one embodiment, a given search space is a search space, a given CORESET is a CORESET associated with the given search space, and the given search space set is associated with the given CORESET.

In one embodiment, the meaning of the phrase of “the given search space set being associated with the given CORESET” comprises: any control channel candidate in the given search space set consists of at least one CCE in the given CORESET.

In one embodiment, the meaning of the phrase of “the given search space set being associated with the given CORESET” comprises: the given CORESET is used to determine time-frequency resources occupied by the given search space set in a monitoring occasion.

In one embodiment, the meaning of the phrase of “the given search space set being associated with the given CORESET” comprises: the given CORESET is used to determine frequency-domain resources occupied by the given search space set in a monitoring occasion.

In one embodiment, the meaning of the phrase of “the given search space set being associated with the given CORESET” comprises: a number of RE(s) occupied by the given search space set in a monitoring occasion is equal to a number of RE(s) occupied by the given CORESET.

In one embodiment, the meaning of the phrase of “the given search space set being associated with the given CORESET” comprises: an RB occupied by the given search space set in frequency domain is an RB occupied by the given CORESET in frequency domain.

In one embodiment, the meaning of the phrase of “the given search space set being associated with the given CORESET” comprises: a number of RB(s) occupied by the given search space set in frequency domain is equal to a number of RB(s) occupied by the given CORESET in frequency domain.

In one embodiment, the meaning of the phrase of “the given search space set being associated with the given CORESET” comprises: frequency-domain resources occupied by the given search space set are frequency-domain resources occupied by the given CORESET.

In one embodiment, the meaning of the phrase of “the given search space set being associated with the given CORESET” comprises: a number of symbol(s) occupied by the given CORESET is used to determine a number of symbol(s) occupied by the given search space set in a detection occasion.

In one embodiment, the meaning of the phrase of “the given search space set being associated with the given CORESET” comprises: a number of symbol(s) occupied by the given search space set in a detection occasion is equal to a number of symbol(s) occupied by the given CORESET.

In one embodiment, the meaning of the phrase of “the given search space set being associated with the given CORESET” comprises: configuration information of the given search space set comprises an index of the given CORESET.

In one embodiment, the meaning of the phrase of “the given search space set being associated with the given CORESET” comprises: an IE configuring the given search space set comprises an index of the given CORESET.

In one embodiment, the monitoring occasion comprises a duration.

In one embodiment, the monitoring occasion comprises at least one symbol.

In one embodiment, the monitoring occasion comprises more than one continuous symbol.

In one embodiment, the monitoring occasion comprises a slot.

In one embodiment, the monitoring occasion comprises a sub-slot.

In one embodiment, the monitoring occasion comprises a sub-frame.

In one embodiment, for the specific definition of the Monitoring Occasion, refer to 3GPP TS38.213.

In one embodiment, the phrase of “occupied frequency-domain resources” refers to: an occupied subcarrier.

In one embodiment, the phrase of “occupied frequency-domain resources” refers to: an occupied RB.

In one embodiment, the phrase of “occupied time-domain resources” refers to: an occupied symbol.

In one embodiment, the phrase of “occupied time-domain resources” refers to: an occupied time.

In one embodiment, the phrase of “occupied time-frequency resources” refers to: an occupied RE.

In one embodiment, the first search space set is on the first cell, or, the first search space set is on the second cell, or the first search space set comprises a control channel candidate on the first cell and a control channel candidate on the second cell.

In one embodiment, whether the first search space set comprises a control channel candidate on the first cell is related to whether the second information comprises at least one field in the first field subset.

In one embodiment, whether the first search space set comprises a control channel candidate on the second cell is related to whether the second information comprises the first field subset.

### Embodiment 2

Embodiment 2 illustrates a schematic diagram of a network architecture according to one embodiment of the present application, as shown in FIG. 2.

FIG. 2 is a diagram illustrating a network architecture 200 of Long-Term Evolution (LTE), Long-Term Evolution Advanced (LTE-A) and future 5G systems. The LTE, LTE-A and future 5G systems network architecture 200 may be called an Evolved Packet System (EPS) 200. The 5G NR or LTE network architecture 200 may be called a 5G System (5GS)/Evolved Packet System (EPS) 200 or other appropriate terms. The 5GS/EPS 200 may comprise one or more UEs 201, a UE 241 that is in Sidelink communications with a UE 201, an NG-RAN 202, a 5G-Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, wearable devices, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Services.

In one embodiment, the first node in the present application comprises the UE 201.

In one embodiment, the second node in the present application comprises the UE 241.

In one embodiment, the second node in the present application comprises the gNB 203.

### Embodiment 3

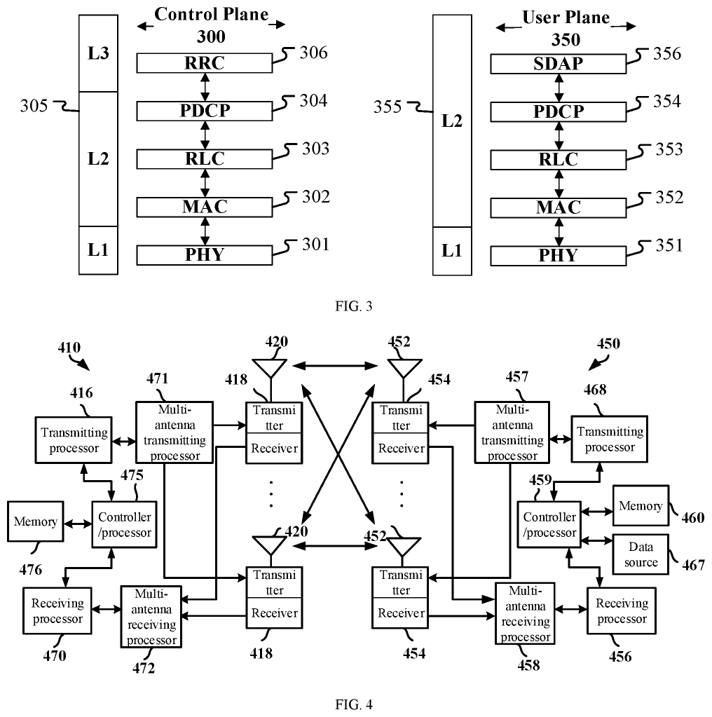

Embodiment 3 illustrates a schematic diagram of a radio protocol architecture of a user plane and a control plane according to one embodiment of the present application, as shown in FIG. 3.

Embodiment 3 illustrates a schematic diagram of an example of a radio protocol architecture of a user plane and a control plane according to one embodiment of the present application, as shown in FIG. 3. FIG. 3 is a schematic diagram illustrating an embodiment of a radio protocol architecture of a user plane 350 and a control plane 300. In FIG. 3, the radio protocol architecture for a first communication node (UE, gNB or an RSU in V2X) and a second communication node (gNB, UE or an RSU in V2X), or between two UEs is represented by three layers, which are a layer 1, a layer 2 and a layer 3, respectively. The layer 1 (L1) is the lowest layer and performs signal processing functions of various PHY layers. The L1 is called PHY 301 in the present application. The layer 2 (L2) 305 is above the PHY 301, and is in charge of a link between a first communication node and a second communication node, or between two UEs. L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication node. The PDCP sublayer 304 provides multiplexing among variable radio bearers and logical channels. The PDCP sublayer 304 provides security by encrypting a packet and provides support for a first communication node handover between second communication nodes. The RLC sublayer 303 provides segmentation and reassembling of a higher-layer packet, retransmission of a lost packet, and reordering of a data packet so as to compensate the disordered receiving caused by HARQ. The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. The Radio Resource Control (RRC) sublayer 306 in layer 3 (L3) of the control plane 300 is responsible for acquiring radio resources (i.e., radio bearer) and configuring the lower layer with an RRC signaling between a second communication node and a first communication node device. The radio protocol architecture of the user plane 350 comprises layer 1 (L1) and layer 2 (L2). In the user plane 350, the radio protocol architecture for the first communication node and the second communication node is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also includes Service Data Adaptation Protocol (SDAP) sublayer 356, which is responsible for the mapping between QoS flow and Data Radio Bearer (DRB) to support the diversity of traffic. Although not described in FIG. 3, the first communication node may comprise several higher layers above the L2 layer 355, such as a network layer (e.g., IP layer) terminated at a P-GW of the network side and an application layer terminated at the other side of the connection (e.g., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first information block is generated by the RRC sublayer 306.

In one embodiment, the second information block is generated by the RRC sublayer 306.

In one embodiment, the monitoring for a control channel candidate scheduling the first cell in the first search space is generated by the PHY 301, or the PHY 351.

In one embodiment, the first signaling is generated by the PHY 301 or the PHY 351.

In one embodiment, the first signal is generated by the PHY 301 or the PHY 351.

### Embodiment 4

Embodiment 4 illustrates a schematic diagram of a first communication device and a second communication device according to one embodiment of the present application, as shown in FIG. 4. FIG. 4 is a block diagram of a first communication device 410 in communication with a second communication device 450 in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from the core network is provided to a controller/processor 475. The controller/processor 475 provides a function of the L2 layer. In DL transmission, the controller/processor 475 provides header compression, encryption, packet segmentation and reordering, and multiplexing between a logical channel and a transport channel, and radio resource allocation for the second communication device 450 based on various priorities. The controller/processor 475 is also in charge of HARQ operation, retransmission of a lost packet, and a signaling to the second communication node 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 450, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more parallel streams. The transmitting processor 416 then maps each parallel stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted on the physical channel by the first communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In downlink (DL) transmission, the controller/processor 459 provides demultiplexing between a transport channel and a logical channel, packet reassembling, decryption, header decompression and control signal processing so as to recover a higher-layer packet from the core network. The higher-layer packet is later provided to all protocol layers above the L2 layer, or various control signals can be provided to the L3 layer for processing. The controller/processor 459 also performs error detection using ACK and/or NACK protocols as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL transmission, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for HARQ operation, retransmission of a lost packet, and a signaling to the first communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated parallel streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. the controller/processor 475 provides de-multiplexing between a transport channel and a logical channel, packet reassembling, decryption, header decompression, control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least: receives a first information block and a second information block; and monitors a control channel candidate scheduling a first cell in a first search space set; herein, both the second information block and the first information block are for the first cell, the first information block indicates that a scheduling cell of the first cell comprises a second cell, and the second information block is used to indicate the first search space set; the second information block comprises at least a first field set in the first field set and a second field set, and the second field set comprises a first field subset; when the second information block does not comprise the first field subset, the first search space set is on the second cell; when the second information block comprises at least one field in the first field subset, whether the second information block comprises a target field is used to determine whether a first search space set comprises a control channel candidate on the second cell, and the target field belongs to the first field subset; when the second information comprises the target field, the first search space set comprises a first control channel candidate set and a second control channel candidate set, the first control channel candidate set is on the first cell, and the second control channel candidate set is on the second cell; when the second information block comprises at least one field in the first field subset and the second information block does not comprise the target field, the first search space set is on the first cell.

In one embodiment, the second communication device 450 comprises a memory that stores a computer readable instruction program. The computer readable instruction program generates an action when executed by at least one processor. The action includes: receiving a first information block and a second information block; and monitoring a control channel candidate scheduling a first cell in a first search space set; herein, both the second information block and the first information block are for the first cell, the first information block indicates that a scheduling cell of the first cell comprises a second cell, and the second information block is used to indicate the first search space set; the second information block comprises at least a first field set in the first field set and a second field set, and the second field set comprises a first field subset; when the second information block does not comprise the first field subset, the first search space set is on the second cell; when the second information block comprises at least one field in the first field subset, whether the second information block comprises a target field is used to determine whether a first search space set comprises a control channel candidate on the second cell, and the target field belongs to the first field subset; when the second information comprises the target field, the first search space set comprises a first control channel candidate set and a second control channel candidate set, the first control channel candidate set is on the first cell, and the second control channel candidate set is on the second cell; when the second information block comprises at least one field in the first field subset and the second information block does not comprise the target field, the first search space set is on the first cell.

In one embodiment, the first communication device 410 comprises at least one processor and at least one memory. The at least one memory comprises computer program codes; the at least one memory and the computer program codes are configured to be used in collaboration with the at least one processor. The first communication device 410 at least: transmits a first information block and a second information block; herein, both the second information block and the first information block are for a first cell, the first information block indicates that a scheduling cell of the first cell comprises a second cell, and the second information block is used to indicate a first search space set; the second information block comprises at least a first field set in the first field set and a second field set, and the second field set comprises a first field subset; when the second information block does not comprise the first field subset, the first search space set is on the second cell; when the second information block comprises at least one field in the first field subset, whether the second information block comprises a target field is used to determine whether a first search space set comprises a control channel candidate on the second cell, and the target field belongs to the first field subset; when the second information comprises the target field, the first search space set comprises a first control channel candidate set and a second control channel candidate set, the first control channel candidate set is on the first cell, and the second control channel candidate set is on the second cell; when the second information block comprises at least one field in the first field subset and the second information block does not comprise the target field, the first search space set is on the first cell.

In one embodiment, the first communication device 410 comprises a memory that stores a computer readable instruction program. The computer readable instruction program generates an action when executed by at least one processor. The action includes: transmitting a first information block and a second information block; herein, both the second information block and the first information block are for a first cell, the first information block indicates that a scheduling cell of the first cell comprises a second cell, and the second information block is used to indicate a first search space set; the second information block comprises at least a first field set in the first field set and a second field set, and the second field set comprises a first field subset; when the second information block does not comprise the first field subset, the first search space set is on the second cell; when the second information block comprises at least one field in the first field subset, whether the second information block comprises a target field is used to determine whether a first search space set comprises a control channel candidate on the second cell, and the target field belongs to the first field subset; when the second information comprises the target field, the first search space set comprises a first control channel candidate set and a second control channel candidate set, the first control channel candidate set is on the first cell, and the second control channel candidate set is on the second cell; when the second information block comprises at least one field in the first field subset and the second information block does not comprise the target field, the first search space set is on the first cell.

In one embodiment, the first node comprises the second communication device 450 in the present application.

In one embodiment, the second node in the present application comprises the first communication device 410.

In one embodiment, at least one of the antenna 452, the receiver 454, the receiving processor 456, the multi-antenna receiving processor 458, the controller/processor 459, the memory 460, or the data source 467 is used to receive the first information block and the second information block in the present application.

In one embodiment, at least one of the antenna 420, the transmitter 418, the multi-antenna transmitting processor 416, the multi-antenna transmitting processor 471, the controller/processor 475, or the memory 476 is used to transmit the first information block and the second information block in the present application.

In one embodiment, at least one of the antenna 452, the receiver 454, the receiving processor 456, the multi-antenna receiving processor 458, the controller/processor 459, the memory 460, or the data source 467 is used to monitor a control channel candidate scheduling the first cell in the first search space set in the present application.

In one embodiment, at least one of the antenna 452, the receiver 454, the receiving processor 456, the multi-antenna receiving processor 458, the controller/processor 459, the memory 460, or the data source 467 is used to receive the first signaling in the present application.

In one embodiment, at least one of the antenna 420, the transmitter 418, the transmitting processor 416, the multi-antenna transmitting processor 471, the controller/processor 475, or the memory 476 is used to transmit the first signaling in the present application.

In one embodiment, at least one of the antenna 452, the receiver 454, the receiving processor 456, the multi-antenna receiving processor 458, the controller/processor 459, the memory 460, or the data source 467 is used to operate the first signaling in the present application, and the operating action is receiving.

In one embodiment, at least one of the antenna 420, the transmitter 418, the multi-antenna transmitting processor 416, the multi-antenna transmitting processor 471, the controller/processor 475, or the memory 476 is used to execute the first signaling in the present application, the executing action is transmitting.

In one embodiment, at least one of the antenna 452, the transmitter 454, the transmitting processor 468, the multi-antenna transmitting processor 457, the controller/processor 459, or the memory 460 is used to operate the first signaling in the present application, and the operating action is transmitting.

In one embodiment, at least one of the antenna 420, the receiver 418, the receiving processor 470, the multi-antenna receiving processor 472, the controller/processor 475, or the memory 476 is used to execute the first signal group in the present application, and the executing action is receiving.

### Embodiment 5

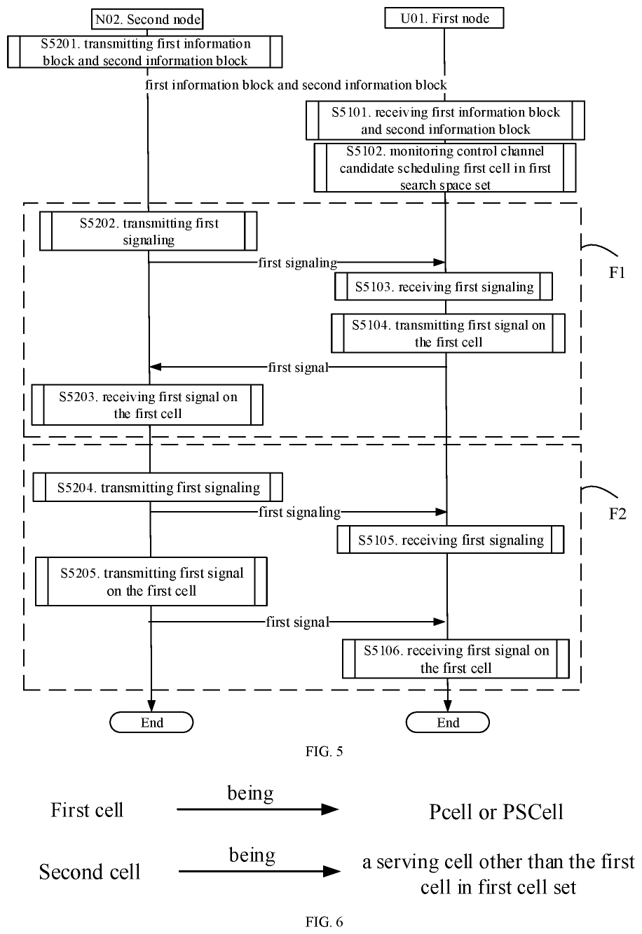

Embodiment 5 illustrates a flowchart of wireless transmission according to one embodiment in the present application, as shown in FIG. 5. In FIG. 5, a first node U01 and a second node N02 are two communication nodes transmitted via an air interface, where steps in dotted box F1 and F2 are optional.

The first node U01 receives a first information block and a second information block in step S5101; monitors a control channel candidate scheduling a first cell in a first search space set in step S5102; receives a first signaling in step S5103; transmits a first signal on the first cell in step S5104; receives a first signaling in step S5105; and receives a first signal on the first cell in step S5106;

The second node N02 transmits a first information block and a second information block in step S5201; transmits a first signaling in step S5202, receives a first signal on the first cell in step S5203; transmits a first signaling in step S5204; and transmits a first signal on the first cell in step S5205.

In embodiment 5, both the second information block and the first information block are for the first cell, the first information block indicates that a scheduling cell of the first cell comprises a second cell, and the second information block is used to indicate the first search space set; the second information block comprises at least a first field set in the first field set and a second field set, and the second field set comprises a first field subset; when the second information block does not comprise the first field subset, the first search space set is on the second cell; when the second information block comprises at least one field in the first field subset, whether the second information block comprises a target field is used to determine whether a first search space set comprises a control channel candidate on the second cell, and the target field belongs to the first field subset; when the second information comprises the target field, the first search space set comprises a first control channel candidate set and a second control channel candidate set, the first control channel candidate set is on the first cell, and the second control channel candidate set is on the second cell; when the second information block comprises at least one field in the first field subset and the second information block does not comprise the target field, the first search space set is on the first cell. The operating action is transmitting, or the operating action is receiving; the executing action is receiving, or, the executing action is transmitting; the first information block indicates a first value; the first signaling occupies a control channel candidate in the first search space set; the first signaling schedules the first signal; when the control channel candidate in the first search space set occupied by the first signaling is on the second cell, the first signaling comprises a first field, and a value of the first field in the first signaling is equal to the first value.

In one embodiment, the dotted boxes F1 and F2 do not exist.

In one embodiment, one and only one between the dotted box F1 and F2 exists.

In one embodiment, the operating action is transmitting, and the executing action is receiving; or, the operating action is receiving, and the executing action is transmitting.

In one embodiment, the operating action is transmitting, and the executing action is receiving.

In one embodiment, the operating action is receiving, and the executing action is transmitting.

In one embodiment, the first signaling is a physical-layer signaling.

In one embodiment, the first signaling is a control signaling.

In one embodiment, the first signaling is a Downlink Control Information (DCI) signaling.

In one embodiment, the first signaling is transmitted through a Physical Downlink Control Channel (PDCCH).

In one embodiment, the first signaling is a DCI signaling, and the first signal is a Physical Downlink Shared Channel (PDSCH).

In one embodiment, the first signal comprises a PDSCH transmission.

In one embodiment, the first signal carries a Transport Block (TB).

In one embodiment, the first signal carries at least one TB.

In one embodiment, the first signal carries a Code block group (CBG).

In one embodiment, the first signal carries at least one CBG.

In one embodiment, the first signaling comprises scheduling information of the first signal.

In one embodiment, scheduling information of the first signal comprises at least one of occupied time-domain resources, occupied frequency-domain resources, a Modulation and Coding Scheme (MCS), configuration information of DeModulation Reference Signals (DMRS), a Hybrid Automatic Repeat reQuest (HARQ) process number, a Redundancy Version (RV), a New Data Indicator (NDI), a transmitting antenna port, a Transmission Configuration Indicator (TCI) state, a Sounding Reference Signal (SRS) resource indication or pre-coding information and layers.

In one embodiment, the first information block comprises at least one field, and one field comprised in the first information block indicates the first value.

In one embodiment, a cif-InSchedulingCell field in the first information block indicates the first value.

In one embodiment, the first value is a Carrier Indicator Field (CIF) value.

In one embodiment, the first value is a positive integer.

In one embodiment, the first value is a positive integer from 1 to 7.

In one embodiment, the first field is a Carrier indicator field.

In one embodiment, a value range of the first field is 0, 1, . . . , 7.

In one embodiment, a value of the first field being 0 represents self-scheduling, and a value of the first field being a non-zero positive integer represents cross-carrier scheduling.

In one embodiment, the first field indicates a scheduled cell.

In one embodiment, the first field comprises 3 bits.

In one embodiment, “a value of the first field in the first signaling being equal to the first value” indicates that a cell scheduled by the first signaling is the first cell.

In one embodiment, for the specific definition of the Carrier indicator field, refer to section 7.3.1 in 3GPP TS 38.212.

### Embodiment 6

Embodiment 6 illustrates a schematic diagram of a first cell and a second cell according to one embodiment of the present application, as shown in FIG. 6.

In embodiment 6, the first cell is a PCell or a PSCell, the second cell is a serving cell other than the first cell in a first cell set, and the first cell set comprises at least the first cell and the second cell.

In one embodiment, the first cell set comprises multiple serving cells, and the first cell and the second cell are two serving cells in the first cell set.

In one embodiment, the first cell set is a Master Cell Group (MCG) or a Secondary Cell Group (SCG).

In one embodiment, the first cell set is an MCG, and the first cell is a Primary Cell (PCell).

In one embodiment, the first cell set is an SCG, and the first cell is a Primary Secondary Cell (PSCell).

In one embodiment, the second cell is a Secondary Cell (SCell).

### Embodiment 7

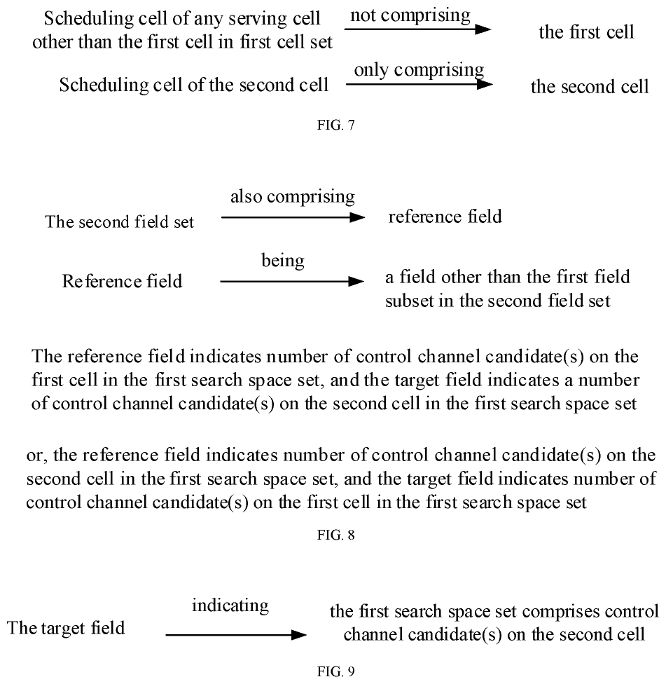

Embodiment 7 illustrates a schematic diagram of a first cell and a second cell according to another embodiment of the present application, as shown in FIG. 7.

In embodiment 7, a scheduling cell of any serving cell other than the first cell in a first cell set does not comprise the first cell, a scheduling cell of the second cell only comprises the second cell, and the first cell set comprises at least the first cell and the second cell.

In one embodiment, the first cell can only be self-scheduled.

In one embodiment, the second cell can be self-scheduled, and the second cell can cross-carrier schedule at least the first cell in the first cell set.

In one embodiment, any serving cell other than the first cell and the second cell in the first cell set cannot schedule the first cell and the second cell.

In one embodiment, in the first cell set, only the first cell can be self-scheduled and be cross-carrier scheduled by the second cell.

### Embodiment 8

Embodiment 8 illustrates a schematic diagram of a target field according to one embodiment of the present application, as shown in FIG. 8.

In embodiment 8, the second field set also comprises a reference field, and the reference field is a field other than the first field subset in the second field set; the reference field indicates a number of control channel candidate(s) on the first cell in the first search space set, and the target field indicates a number of control channel candidate(s) on the second cell in the first search space set; or, the reference field indicates a number of control channel candidate(s) on the second cell in the first search space set, and the target field indicates a number of control channel candidate(s) on the first cell in the first search space set.

In one embodiment, the number of the control signaling candidate(s) on the first cell in the first search space set is a number of control channel candidate(s) of each CCE aggregation level on the first cell in the first search space set.

In one embodiment, the number of the control signaling candidate(s) on the first cell in the first search space set is a number of control channel candidate(s) of at least one CCE aggregation level on the first cell in the first search space set.

In one embodiment, the reference field is a nrofCandidates field.

In one embodiment, a name of the reference field comprises nrofCandidates.

In one embodiment, the second field subset comprises the reference field.

In one embodiment, the second field subset only comprises the reference field.

In one embodiment, the second field subset at least comprises the reference field.

### Embodiment 9

Embodiment 9 illustrates a schematic diagram of a target field according to another embodiment of the present application, as shown in FIG. 9.

In embodiment 9, the target field indicates that the first search space set comprises control channel candidate(s) on the second cell.

In one embodiment, the target field and the reference field are different fields.

### Embodiment 10

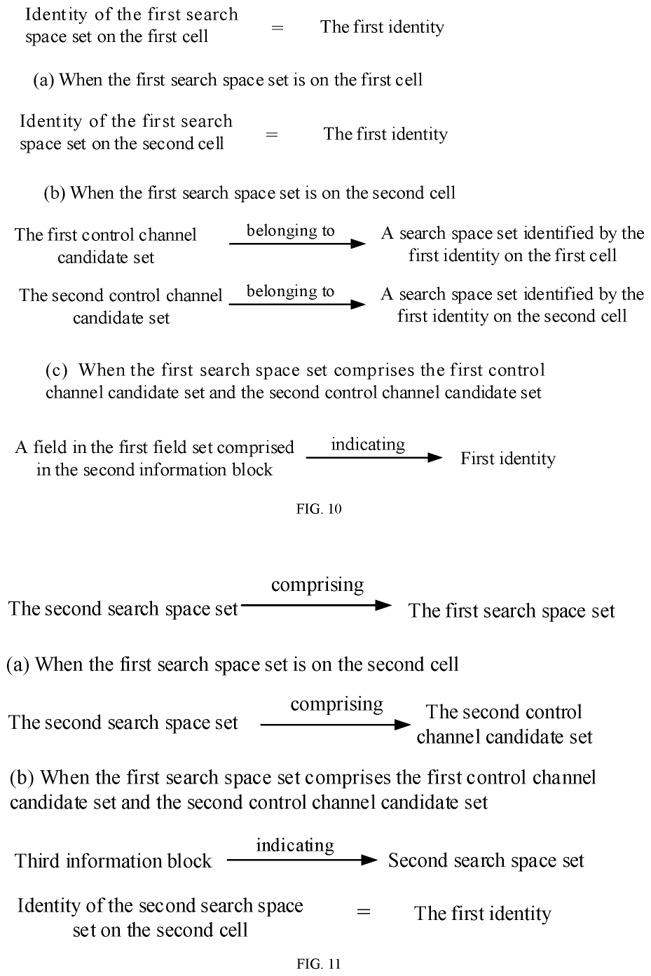

Embodiment 10 illustrates a schematic diagram of a relation between a first search space set and a first identity according to one embodiment of the present application, as shown in FIG. 10.

In embodiment 10, one field in the first field set comprised in the second information block indicates a first identity; when the first search space set is on the first cell, an identity of the first search space set on the first cell is equal to the first identity; when the first search space set is on the second cell, an identity of the first search space set on the second cell is equal to the first identity; when the first search space set comprises the first control channel candidate set and the second control channel candidate set, the first control channel candidate set belongs to a search space set identified by the first identity on the first cell, and the second control channel candidate set belongs to a search space set identified by the first identity on the second cell.

In one embodiment, the field indicating the first identity in the first field set comprised in the second information block is a searchSpaceId field.

In one embodiment, the first identity is a non-negative integer.

In one embodiment, an identity of the first search space set on the first cell is used to identify the first search space set on the first cell, and an identity of the second search space set on the second cell is used to identify the second search space set on the second cell.

In one embodiment, the meaning of the phrase of “the first control channel candidate set belonging to a search space set identified by the first identity on the first cell” comprises: the search space set identified by the first identity on the first cell only comprises the first control channel candidate set.

In one embodiment, the meaning of the phrase of “the first control channel candidate set belonging to a search space set identified by the first identity on the first cell” comprises: the search space set identified by the first identity on the first cell at least comprises the first control channel candidate set.

In one embodiment, the meaning of the phrase of “the first control channel candidate set belonging to a search space set identified by the first identity on the first cell” comprises: the search space set identified by the first identity on the first cell comprises the first control channel candidate set and at least one control channel candidate other than the first control channel candidate set.

In one embodiment, the meaning of the phrase of “the second control channel candidate set belonging to a search space set identified by the first identity on the second cell” comprises: the search space set identified by the first identity on the second cell only comprises the second control channel candidate set.

In one embodiment, the meaning of the phrase of “the second control channel candidate set belonging to a search space set identified by the first identity on the second cell” comprises: the search space set identified by the first identity on the second cell at least comprises the second control channel candidate set.

In one embodiment, the meaning of the phrase of “the second control channel candidate set belonging to a search space set identified by the first identity on the second cell” comprises: the search space set identified by the first identity on the second cell comprises the second control channel candidate set and at least one control channel candidate other than the second control channel candidate set.

### Embodiment 11

Embodiment 11 illustrates a schematic diagram of a relation between a second search space set and a first space set according to one embodiment of the present application, as shown in FIG. 11.

In embodiment 11, the first receiver receives a third information block; herein, the third information block is for the second cell, the third information block indicates a second search space set, the second search space set is on the second cell, and an identity of the second search space set on the second cell is equal to the first identity; when the first search space set is on the second cell, the second search space set comprises the first search space set; when the first search space set comprises the first control channel candidate set and the second control channel candidate set, the second search space set comprises the second control channel candidate.

In one embodiment, the third information block comprises partial or all fields in an IE.

In one embodiment, the third information block comprises an IE SearchSpace.

In one embodiment, the third information block is carried by a higher-layer signaling.

In one embodiment, the third information block is carried by an RRC signaling.

In one embodiment, the second information block and the third information block respectively comprise different IEs.

In one embodiment, the second information block and the third information block are two IE Se arch Spaces.

In one embodiment, the second information block and the third information block respectively belong to two IE ServingCellConfigs, and the two IE ServingCellConfigs are respectively for the first cell and the second cell.

In one embodiment, the meaning of the phrase of “the third information being for the second cell” comprises: the third information block is configured to the second cell.

In one embodiment, the meaning of the phrase of “the third information being for the second cell” comprises: a downlinkBWP-ToAddModList field in an IE ServingCellConfig for the second cell comprises the third information block.

In one embodiment, the meaning of the phrase of “the third information being for the second cell” comprises: a field in an IE ServingCellConfig for the second cell comprises the third information block.

In one embodiment, the third information block indicates configuration information of the second search space set.

In one embodiment, the third information block comprises the first field set, and at least one field in the first field subset.

In one embodiment, the third information block at least comprises the first field set, and at least one field in the first field subset.

In one embodiment, the third information block comprises the first field set, a reference field and at least one field in the first field subset.

In one embodiment, the meaning of the phrase of “the second search space set comprising the first search space set” comprises: the second search space set at least comprises the first search space set.

In one embodiment, the meaning of the phrase of “the second search space set comprising the first search space set” comprises: the second search space set only comprises the first search space set.

In one embodiment, the meaning of the phrase of “the second search space set comprising the first search space set” comprises: the second search space set comprises the first search space set and at least one control channel candidate other than the first search space set.

In one embodiment, the meaning of the phrase of “the second search space set comprising the second search space set” comprises: the second search space set at least comprises the second search space set.

In one embodiment, the meaning of the phrase of “the second search space set comprising the second search space set” comprises: the second search space set only comprises the second search space set.

In one embodiment, the meaning of the phrase of “the second search space set comprising the second search space set” comprises: the second search space set comprises the second search space set and at least one control channel candidate other than the second search space set.

### Embodiment 12

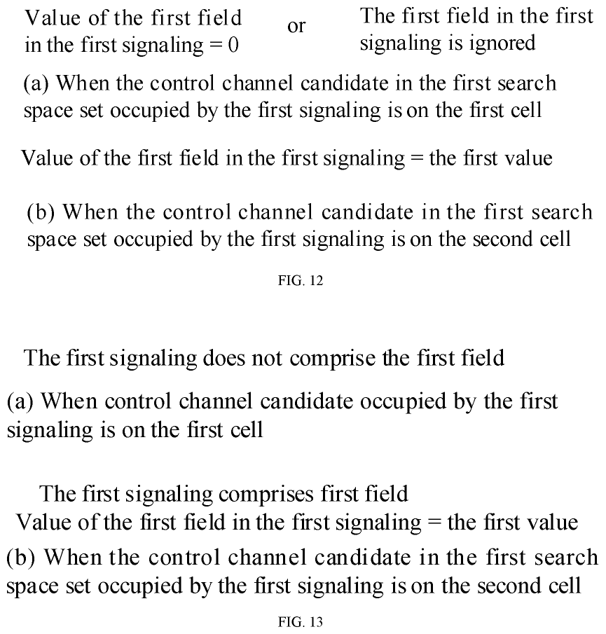

Embodiment 12 illustrates a schematic diagram of a first field in a first signaling according to one embodiment of the present application, as shown in FIG. 12.

In Embodiment 12, the first signaling comprises a first field; when the control channel candidate in the first search space set occupied by the first signaling is on the first cell, a value of the first field in the first signaling is equal to 0, or, the first field in the first signaling is ignored; when the control channel candidate in the first search space set occupied by the first signaling is on the second cell, a value of the first field in the first signaling is equal to the first value.

In one embodiment, the first signaling comprises a first field, an interpretation for the first field in the first signaling is related to whether the control channel candidate in the first search space set occupied by the first signaling is on the first cell or the second cell.

In one embodiment, the first signaling comprises a first field; when the control channel candidate in the first search space set occupied by the first signaling is on the first cell, a value of the first field in the first signaling is equal to 0; when the control channel candidate in the first search space set occupied by the first signaling is on the second cell, a value of the first field in the first signaling is equal to the first value.

In one embodiment, when the control channel candidate in the first search space set occupied by the first signaling is on the first cell, the first field in the first signaling is ignored; when the control channel candidate in the first search space set occupied by the first signaling is on the second cell, the first signaling comprises a first field, and a value of the first field in the first signaling is equal to the first value.

In one embodiment, the meaning of the phrase of “the first field in the first signaling being ignored” comprises: a value of the first field in the first signaling is ignored.

In one embodiment, the meaning of the phrase of “the first field in the first signaling being ignored” comprises: the first field in the first signaling is reserved.

In one embodiment, the meaning of the phrase of “a value of the first field in the first signaling being ignored” comprises: a value of the first field in the first signaling is not used to determine the first signal.

In one embodiment, the meaning of the phrase of “a value of the first field in the first signaling being ignored” comprises: a value of the first field in the first signaling is not used to determine a serving cell where the first signal is located.

### Embodiment 13

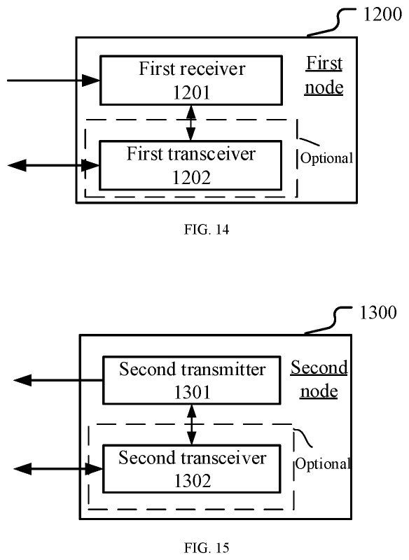

Embodiment 13 illustrates a schematic diagram of a first field in a first signaling according to another embodiment of the present application, as shown in FIG. 13.

In embodiment 13, whether the first signaling comprises the first field is related to whether a control channel candidate occupied by the first signaling is on the first cell or on the second cell; when a control channel candidate occupied by the first signaling is on the first cell, the first signaling does not comprise the first field; when the control channel candidate in the first search space set occupied by the first signaling is on the second cell, the first signaling comprises a first field, and a value of the first field in the first signaling is equal to the first value.

### Embodiment 14

Embodiment 14 illustrates a structure block diagram of a processor in a first node according to one embodiment of the present application, as shown in FIG. 14. In FIG. 14, a processor 1200 in a first node comprises a first receiver 1201, where a first transceiver 1202 is optional.

In one embodiment, the first node is a UE.

In one embodiment, the first node is a relay node.

In one embodiment, the first receiver 1201 comprises at least one of the antenna 452, the receiver 454, the receiving processor 456, the multi-antenna receiving processor 458, the controller/processor 459, the memory 460, or the data source 467 in Embodiment 4.

In one embodiment, the first transceiver 1202 comprises at least one of the antenna 452, the receiver/transmitter 454, the receiving processor 456, the multi-antenna receiving processor 458, the transmitting processor 468, the multi-antenna transmitting processor 457, the controller/processor 459, the memory 460 or the data source 467 in Embodiment 4.

The first receiver 1201: receives a first information block and a second information block; monitors a control channel candidate scheduling a first cell in a first search space set;

In embodiment 14, both the second information block and the first information block are for the first cell, the first information block indicates that a scheduling cell of the first cell comprises a second cell, and the second information block is used to indicate the first search space set; the second information block comprises at least a first field set in the first field set and a second field set, and the second field set comprises a first field subset; when the second information block does not comprise the first field subset, the first search space set is on the second cell; when the second information block comprises at least one field in the first field subset, whether the second information block comprises a target field is used to determine whether a first search space set comprises a control channel candidate on the second cell, and the target field belongs to the first field subset; when the second information comprises the target field, the first search space set comprises a first control channel candidate set and a second control channel candidate set, the first control channel candidate set is on the first cell, and the second control channel candidate set is on the second cell; when the second information block comprises at least one field in the first field subset and the second information block does not comprise the target field, the first search space set is on the first cell.

In one embodiment, the first cell is a PCell or a PSCell, the second cell is a serving cell other than the first cell in a first cell set, and the first cell set comprises at least the first cell and the second cell.

In one embodiment, the second field set also comprises a reference field, and the reference field is a field other than the first field subset in the second field set; the reference field indicates a number of control channel candidate(s) on the first cell in the first search space set, and the target field indicates a number of control channel candidate(s) on the second cell in the first search space set; or, the reference field indicates a number of control channel candidate(s) on the second cell in the first search space set, and the target field indicates a number of control channel candidate(s) on the first cell in the first search space set.

In one embodiment, the target field indicates that the first search space set comprises control channel candidate(s) on the second cell.

In one embodiment, one field in the first field set comprised in the second information block indicates a first identity; when the first search space set is on the first cell, an identity of the first search space set on the first cell is equal to the first identity; when the first search space set is on the second cell, an identity of the first search space set on the second cell is equal to the first identity; when the first search space set comprises the first control channel candidate set and the second control channel candidate set, the first control channel candidate set belongs to a search space set identified by the first identity on the first cell, and the second control channel candidate set belongs to a search space set identified by the first identity on the second cell.

In one embodiment, comprising:

the first receiver 1201 receives a first signaling; and

the first transceiver 1202 operates a first signal on the first cell;

herein, the operating action is transmitting, or the operating action is receiving; the first information block indicates a first value; the first signaling occupies a control channel candidate in the first search space set;

the first signaling schedules the first signal; when the control channel candidate in the first search space set occupied by the first signaling is on the second cell, the first signaling comprises a first field, and a value of the first field in the first signaling is equal to the first value.

In one embodiment, when the control channel candidate in the first search space set occupied by the first signaling is on the first cell, a value of the first field in the first signaling is equal to 0, or, the first field in the first signaling is ignored.

In one embodiment, whether the first signaling comprises the first field is related to whether a control channel candidate occupied by the first signaling is on the first cell or on the second cell; when a control channel candidate occupied by the first signaling is on the first cell, the first signaling does not comprise the first field.

### Embodiment 15

Embodiment 15 illustrates a structure block diagram of a processor in a second node according to one embodiment of the present application, as shown in FIG. 15. In FIG. 15, a processor 1300 in a second node comprises a second transmitter 1301; where a second transceiver 1302 is optional.

In one embodiment, the second node is a base station.

In one embodiment, the second node is a UE.

In one embodiment, the second node is a relay node.

In one embodiment, the second transmitter 1301 comprises at least one of the antenna 420, the transmitter 418, the transmitting processor 416, the multi-antenna transmitting processor 471, the controller/processor 475, or the memory 476 in Embodiment 4.

In one embodiment, the second transceiver 1302 comprises at least one of the antenna 420, the transmitter/receiver 418, the transmitting processor 416, the multi-antenna transmitting processor 471, the receiving processor 470, the multi-antenna receiving processor 472, the controller/processor 475 or memory 476 in Embodiment 4.

The second transmitter 1301 transmits a first information block and a second information block;

In embodiment 15, both the second information block and the first information block are for a first cell, the first information block indicates that a scheduling cell of the first cell comprises a second cell, and the second information block is used to indicate a first search space set; the second information block comprises at least a first field set in the first field set and a second field set, and the second field set comprises a first field subset; when the second information block does not comprise the first field subset, the first search space set is on the second cell; when the second information block comprises at least one field in the first field subset, whether the second information block comprises a target field is used to determine whether a first search space set comprises a control channel candidate on the second cell, and the target field belongs to the first field subset; when the second information comprises the target field, the first search space set comprises a first control channel candidate set and a second control channel candidate set, the first control channel candidate set is on the first cell, and the second control channel candidate set is on the second cell; when the second information block comprises at least one field in the first field subset and the second information block does not comprise the target field, the first search space set is on the first cell.

In one embodiment, the first cell is a PCell or a PSCell, the second cell is a serving cell other than the first cell in a first cell set, and the first cell set comprises at least the first cell and the second cell.

In one embodiment, the second field set also comprises a reference field, and the reference field is a field other than the first field subset in the second field set; the reference field indicates a number of control channel candidate(s) on the first cell in the first search space set, and the target field indicates a number of control channel candidate(s) on the second cell in the first search space set; or, the reference field indicates a number of control channel candidate(s) on the second cell in the first search space set, and the target field indicates a number of control channel candidate(s) on the first cell in the first search space set.

In one embodiment, the target field indicates that the first search space set comprises control channel candidate(s) on the second cell.

In one embodiment, one field in the first field set comprised in the second information block indicates a first identity; when the first search space set is on the first cell, an identity of the first search space set on the first cell is equal to the first identity; when the first search space set is on the second cell, an identity of the first search space set on the second cell is equal to the first identity; when the first search space set comprises the first control channel candidate set and the second control channel candidate set, the first control channel candidate set belongs to a search space set identified by the first identity on the first cell, and the second control channel candidate set belongs to a search space set identified by the first identity on the second cell.

In one embodiment, comprising:

the second transmitter 1301 transmits a first signaling; and

the second transceiver 1302 executes a first signal on the first cell;

herein, the executing action is receiving, or, the executing action is transmitting; the first information block indicates a first value; the first signaling occupies a control channel candidate in the first search space set; the first signaling schedules the first signal; when the control channel candidate in the first search space set occupied by the first signaling is on the second cell, the first signaling comprises a first field, and a value of the first field in the first signaling is equal to the first value.

In one embodiment, when the control channel candidate in the first search space set occupied by the first signaling is on the first cell, a value of the first field in the first signaling is equal to 0, or, the first field in the first signaling is ignored.

In one embodiment, whether the first signaling comprises the first field is related to whether a control channel candidate occupied by the first signaling is on the first cell or on the second cell; when a control channel candidate occupied by the first signaling is on the first cell, the first signaling does not comprise the first field.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The user equipment, terminal and UE include but are not limited to Unmanned Aerial Vehicles (UAVs), communication modules on UAVs, telecontrolled aircrafts, aircrafts, diminutive airplanes, mobile phones, tablet computers, notebooks, vehicle-mounted communication equipment, wireless sensors, network cards, Internet of Things (IoT) terminals, RFID terminals, NB-IOT terminals, Machine Type Communication (MTC) terminals, enhanced MTC (eMTC) terminals, data card, network cards, vehicle-mounted communication equipment, low-cost mobile phones, low-cost tablets and other wireless communication devices. The UE and terminal in the present application include but not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things, RFID terminals, NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, gNB (NR node B), Transmitter Receiver Point (TRP), and other radio communication equipment.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first information block and a second information block; monitoring a control channel candidate scheduling a first cell in a first search space set;
wherein both the second information block and the first information block are for the first cell, the first information block indicates that a scheduling cell of the first cell comprises a second cell, and the second information block is used to indicate the first search space set; the second information block comprises at least a first field set in the first field set and a second field set, and the second field set comprises a first field subset; when the second information block does not comprise the first field subset, the first search space set is on the second cell; when the second information block comprises at least one field in the first field subset, whether the second information block comprises a target field is used to determine whether a first search space set comprises a control channel candidate on the second cell, and the target field belongs to the first field subset; when the second information comprises the target field, the first search space set comprises a first control channel candidate set and a second control channel candidate set, the first control channel candidate set is on the first cell, and the second control channel candidate set is on the second cell; when the second information block comprises at least one field in the first field subset and the second information block does not comprise the target field, the first search space set is on the first cell.

2. The first node according to claim 1, wherein the second field set also comprises a reference field, the reference field is a field other than the first field subset in the second field set, the reference field indicates a number of control channel candidate(s) on the first cell in the first search space set, the target field indicates a number of control channel candidate(s) on the second cell in the first search space set, or the reference field indicates a number of control channel candidate(s) on the second cell in the first search space set, and the target field indicates a number of control channel candidate(s) on the first cell in the first search space set;
or, the target field indicates that the first search space set comprises control channel candidate(s) on the second cell.

3. The first node according to claim 1, wherein one field in the first field set comprised in the second information block indicates a first identity; when the first search space set is on the first cell, an identity of the first search space set on the first cell is equal to the first identity; when the first search space set is on the second cell, an identity of the first search space set on the second cell is equal to the first identity; when the first search space set comprises the first control channel candidate set and the second control channel candidate set, the first control channel candidate set belongs to a search space set identified by the first identity on the first cell, and the second control channel candidate set belongs to a search space set identified by the first identity on the second cell.

4. The first node according to claim 1, comprising:
the first receiver, receiving a first signaling; and
the first transceiver, operating a first signal on the first cell;
wherein the operating action is transmitting, or the operating action is receiving; the first information block indicates a first value; the first signaling occupies a control channel candidate in the first search space set;
the first signaling schedules the first signal; when the control channel candidate in the first search space set occupied by the first signaling is on the second cell, the first signaling comprises a first field, and a value of the first field in the first signaling is equal to the first value.

5. The first node according to claim 4, wherein when the control channel candidate in the first search space set occupied by the first signaling is on the first cell, a value of the first field in the first signaling is equal to 0, or, the first field in the first signaling is ignored;
or, whether the first signaling comprises the first field is related to whether a control channel candidate occupied by the first signaling is on the first cell or on the second cell, when a control channel candidate occupied by the first signaling is on the first cell, the first signaling does not comprise the first field.

6. A second node for wireless communications, comprising:
a second transmitter, transmitting a first information block and a second information block;
wherein both the second information block and the first information block are for a first cell, the first information block indicates that a scheduling cell of the first cell comprises a second cell, and the second information block is used to indicate a first search space set; the second information block comprises at least a first field set in the first field set and a second field set, and the second field set comprises a first field subset; when the second information block does not comprise the first field subset, the first search space set is on the second cell; when the second information block comprises at least one field in the first field subset, whether the second information block comprises a target field is used to determine whether a first search space set comprises a control channel candidate on the second cell, and the target field belongs to the first field subset; when the second information comprises the target field, the first search space set comprises a first control channel candidate set and a second control channel candidate set, the first control channel candidate set is on the first cell, and the second control channel candidate set is on the second cell; when the second information block comprises at least one field in the first field subset and the second information block does not comprise the target field, the first search space set is on the first cell.

7. The second node according to claim 6, wherein the second field set also comprises a reference field, the reference field is a field other than the first field subset in the second field set, the reference field indicates a number of control channel candidate(s) on the first cell in the first search space set, the target field indicates a number of control channel candidate(s) on the second cell in the first search space set, or the reference field indicates a number of control channel candidate(s) on the second cell in the first search space set, and the target field indicates a number of control channel candidate(s) on the first cell in the first search space set;
or, the target field indicates that the first search space set comprises control channel candidate(s) on the second cell.

8. The second node according to claim 6, wherein one field in the first field set comprised in the second information block indicates a first identity; when the first search space set is on the first cell, an identity of the first search space set on the first cell is equal to the first identity; when the first search space set is on the second cell, an identity of the first search space set on the second cell is equal to the first identity; when the first search space set comprises the first control channel candidate set and the second control channel candidate set, the first control channel candidate set belongs to a search space set identified by the first identity on the first cell, and the second control channel candidate set belongs to a search space set identified by the first identity on the second cell.

9. The second node according to claim 6, comprising:
the second transmitter, transmitting a first signaling; and
the second transceiver, executing a first signal on the first cell;
wherein the executing action is receiving, or, the executing action is transmitting; the first information block indicates a first value; the first signaling occupies a control channel candidate in the first search space set; the first signaling schedules the first signal; when the control channel candidate in the first search space set occupied by the first signaling is on the second cell, the first signaling comprises a first field, and a value of the first field in the first signaling is equal to the first value.

10. The second node according to claim 9, wherein when the control channel candidate in the first search space set occupied by the first signaling is on the first cell, a value of the first field in the first signaling is equal to 0, or, the first field in the first signaling is ignored;
or, whether the first signaling comprises the first field is related to whether a control channel candidate occupied by the first signaling is on the first cell or on the second cell, when a control channel candidate occupied by the first signaling is on the first cell, the first signaling does not comprise the first field.

11. A method in a first node for wireless communications, comprising:
receives a first information block and a second information block; and
monitoring a control channel candidate scheduling a first cell in a first search space set;
wherein both the second information block and the first information block are for the first cell, the first information block indicates that a scheduling cell of the first cell comprises a second cell, and the second information block is used to indicate the first search space set; the second information block comprises at least a first field set in the first field set and a second field set, and the second field set comprises a first field subset; when the second information block does not comprise the first field subset, the first search space set is on the second cell; when the second information block comprises at least one field in the first field subset, whether the second information block comprises a target field is used to determine whether a first search space set comprises a control channel candidate on the second cell, and the target field belongs to the first field subset; when the second information comprises the target field, the first search space set comprises a first control channel candidate set and a second control channel candidate set, the first control channel candidate set is on the first cell, and the second control channel candidate set is on the second cell; when the second information block comprises at least one field in the first field subset and the second information block does not comprise the target field, the first search space set is on the first cell.

12. The method according to claim 11, wherein the second field set also comprises a reference field, the reference field is a field other than the first field subset in the second field set, the reference field indicates a number of control channel candidate(s) on the first cell in the first search space set, the target field indicates a number of control channel candidate(s) on the second cell in the first search space set, or the reference field indicates a number of control channel candidate(s) on the second cell in the first search space set, and the target field indicates a number of control channel candidate(s) on the first cell in the first search space set;
or, the target field indicates that the first search space set comprises control channel candidate(s) on the second cell.

13. The method according to claim 11, wherein one field in the first field set comprised in the second information block indicates a first identity; when the first search space set is on the first cell, an identity of the first search space set on the first cell is equal to the first identity; when the first search space set is on the second cell, an identity of the first search space set on the second cell is equal to the first identity; when the first search space set comprises the first control channel candidate set and the second control channel candidate set, the first control channel candidate set belongs to a search space set identified by the first identity on the first cell, and the second control channel candidate set belongs to a search space set identified by the first identity on the second cell.

14. The method according to claim 11, comprising:
receiving a first signaling; and
operating a first signal on the first cell;
wherein the operating action is transmitting, or the operating action is receiving; the first information block indicates a first value; the first signaling occupies a control channel candidate in the first search space set; the first signaling schedules the first signal; when the control channel candidate in the first search space set occupied by the first signaling is on the second cell, the first signaling comprises a first field, and a value of the first field in the first signaling is equal to the first value. 15. The method according to claim 14, wherein when the control channel candidate in the first search space set occupied by the first signaling is on the first cell, a value of the first field in the first signaling is equal to 0, or, the first field in the first signaling is ignored;
or, whether the first signaling comprises the first field is related to whether a control channel candidate occupied by the first signaling is on the first cell or on the second cell, when a control channel candidate occupied by the first signaling is on the first cell, the first signaling does not comprise the first field.

16. A method in a second node for wireless communications, comprising:
transmitting a first information block and a second information block;
wherein both the second information block and the first information block are for a first cell, the first information block indicates that a scheduling cell of the first cell comprises a second cell, and the second information block is used to indicate a first search space set; the second information block comprises at least a first field set in the first field set and a second field set, and the second field set comprises a first field subset; when the second information block does not comprise the first field subset, the first search space set is on the second cell; when the second information block comprises at least one field in the first field subset, whether the second information block comprises a target field is used to determine whether a first search space set comprises a control channel candidate on the second cell, and the target field belongs to the first field subset; when the second information comprises the target field, the first search space set comprises a first control channel candidate set and a second control channel candidate set, the first control channel candidate set is on the first cell, and the second control channel candidate set is on the second cell; when the second information block comprises at least one field in the first field subset and the second information block does not comprise the target field, the first search space set is on the first cell.

17. The method according to claim 16, wherein the second field set also comprises a reference field, the reference field is a field other than the first field subset in the second field set, the reference field indicates a number of control channel candidate(s) on the first cell in the first search space set, the target field indicates a number of control channel candidate(s) on the second cell in the first search space set, or the reference field indicates a number of control channel candidate(s) on the second cell in the first search space set, and the target field indicates a number of control channel candidate(s) on the first cell in the first search space set;
or, the target field indicates that the first search space set comprises control channel candidate(s) on the second cell.

18. The method according to claim 16, wherein one field in the first field set comprised in the second information block indicates a first identity; when the first search space set is on the first cell, an identity of the first search space set on the first cell is equal to the first identity; when the first search space set is on the second cell, an identity of the first search space set on the second cell is equal to the first identity; when the first search space set comprises the first control channel candidate set and the second control channel candidate set, the first control channel candidate set belongs to a search space set identified by the first identity on the first cell, and the second control channel candidate set belongs to a search space set identified by the first identity on the second cell.

19. The method according to claim 16, comprising:
transmitting a first signaling; and
executing a first signal on the first cell;
wherein the executing action is receiving, or, the executing action is transmitting; the first information block indicates a first value; the first signaling occupies a control channel candidate in the first search space set; the first signaling schedules the first signal; when the control channel candidate in the first search space set occupied by the first signaling is on the second cell, the first signaling comprises a first field, and a value of the first field in the first signaling is equal to the first value.

20. The method according to claim 19, wherein when the control channel candidate in the first search space set occupied by the first signaling is on the first cell, a value of the first field in the first signaling is equal to 0, or, the first field in the first signaling is ignored;
or, whether the first signaling comprises the first field is related to whether a control channel candidate occupied by the first signaling is on the first cell or on the second cell, when a control channel candidate occupied by the first signaling is on the first cell, the first signaling does not comprise the first field.
